(19) United States
(12) Patent Application Publication
(10) Pub. No.: US 2025/0128690 A1
(43) Pub. Date: Apr. 24, 2025

(54) A METHOD FOR ESTIMATING, BY USING FRICTION MAPS, A BRAKING TORQUE OF A BRAKING SYSTEM AND/OR PRESSURE TO BE APPLIED TO A BRAKING SYSTEM

(71) Applicant: Brembo S.p.A., Curno, Bergamo (IT)

(72) Inventor: Andrea MESCHINI, Curno, Bergamo (IT)

(21) Appl. No.: 18/721,932

(22) PCT Filed: Dec. 19, 2022
(86) PCT No.: PCT/IB2022/062451

§ 371 Date: Jun. 20, 2024

(30) Foreign Application Priority Data
Dec. 23, 2021 (IT) 102021000032420

(51) Int. Cl. B60T 17/22; B60T 1/06; B60T 8/171; B60T 8/172; F16D 66/00

(52) U.S. Cl. CPC B60T 17/22; B60T 8/171; B60T 8/172; F16D 66/00; B60T 1/065; B60T 2240/00; B60T 2270/82; F16D 2066/001; F16D 2066/003; F16D 2066/005; F16D 2066/006

(57) ABSTRACT

There is described a method for estimating a braking torque of a braking system for vehicles under operating conditions. Such a method comprises a step a) of detecting or calculating a first input quantity and a second input quantity representative of operating conditions of the braking system. The first detected or calculated input quantity comprises a temperature T of a brake disc of the braking system. The second detected or calculated input quantity comprises a quantity depending on a pressure P of the braking system or on a contact pressure PC between friction surfaces of the braking system. The method then includes a step b) of determining, based on said detected or calculated first input quantity and second input quantity, a braking friction coefficient μ representative of the braking friction or efficiency expected under the conditions defined by the detected or calculated values of said first input quantity and second

### TECHNOLOGICAL BACKGROUND OF THE INVENTION

### Field of Application

The present invention relates to a method for estimating a braking torque of a braking system using friction maps.

The present invention is also directed to a similar method for estimating a pressure to be applied to a braking system using friction maps.

The general technical field of the present invention is thus that of estimating, by means of electronic processing, quantities related to the operation of a braking system, based on measured or detected operating parameters.

### Description of the Prior Art

Until relatively recent times, the characterization of the frictions that are created on the brake disc of a vehicle during a braking event was carried out exclusively by means of experimental test cycles, each of which referred to a specific operating condition and/or situation, or as a function of the disc temperature.

Such a methodology was affected by the obvious and severe drawback of not providing an estimate of the friction for all the possible operating conditions different from those experimentally tested. This implied the further disadvantage of needing to perform a specific characterization test for each use condition of interest.

To partially solve this problem, a more general model was introduced, from which to take significant estimates of friction for a wide range of possible operating conditions, each associated with specific significant variables of values at stake (e.g., temperature of the brake disc and pressure applied to the brake disc).

The results of these models are typically reported in the form of tables (i.e., “friction maps”), which can be consulted to make estimates of friction on the brake disc under different operating conditions.

The friction estimate, in turn, can be useful for estimating other important operating quantities of the braking system (e.g. braking torque, or pressure to be applied to the brake disc to obtain a certain braking torque).

Regarding this, the prior art does not provide any automatic solutions, which is adaptable to a plurality of operating conditions (ideally, usable on any operating condition) and such as to be usable in real time, during the operation of the braking system, and to provide highly reliable results.

Therefore, many needs remain unmet in such a domain, needs for which the solutions known to date do not provide fully effective solutions.

### SUMMARY OF THE INVENTION

It is the object of the present invention to provide a method for estimating a braking torque of a braking system, which allows at least partially obviating the drawbacks complained of above with reference to the prior art, and responding to the aforementioned needs particularly felt in the technical field considered. Such an object is achieved by a method according to claim 1.

Further embodiments of such a method are defined in claims 2-15.

It is also an object of the present invention to provide a method for estimating quantities related to the operation of a braking system for vehicles. Said object is achieved by a method according to claim 16.

Further embodiments of such a method are defined in claims 17-18.

It is also an object of the present invention to provide a method for estimating a pressure to be applied to a braking system of a vehicle. Such an object is achieved by a method according to claim 19 and by a method according to claim 26.

Further embodiments of such a method are defined in claims 20-25 and 27.

Finally, it is also an object of the present invention to provide a method for actuating a braking system mounted on a vehicle provided with brake-by-wire, using the methods mentioned above. Said object is achieved by a method according to claim 28.

### BRIEF DESCRIPTION OF THE DRAWINGS

Further features and advantages of the method according to the invention will become apparent from the following description of preferred embodiments, given by way of non-limiting indication, with reference to the accompanying drawings, in which:

FIG. 1 is a simplified flow diagram of the steps included in an embodiment of the method for estimating a braking torque of a braking system, encompassed by the invention;

FIG. 2 is a simplified flow diagram of the steps included in an embodiment of a method for estimating quantities related to the operation of a braking system for vehicles, encompassed by the invention;

FIG. 3 is a simplified flow diagram of the steps included in an embodiment of a method for estimating a pressure to be applied to a braking system of a vehicle, for obtaining a target braking torque value Ct, encompassed by the invention;

FIG. 4 is a simplified flow diagram of the steps included in another embodiment of a method for estimating a pressure to be applied to a braking system of a vehicle, for obtaining a target braking torque value Ct;

FIG. 5 is a simplified flow diagram of the steps included in another embodiment of a method for actuating a brake-by-wire braking system for vehicles, using the methods mentioned above;

FIGS. 6A and 6B show examples of direct friction maps used in an embodiment of the method according to the invention;

FIG. 7 shows an example of a look-up table corresponding to a direct friction map;

FIG. 8 shows an example of a friction map used in an embodiment of the method according to the invention;

FIG. 9 illustrates a calculation example of an inverse friction map from a direct friction map;

FIG. 10 shows an example of a look-up table corresponding to an inverse friction map;

FIGS. 11A-11C show diagrams of a “brake-by-wire” braking system to which the method in FIG. 5 can be applied;

FIG. 12 illustrates the use of friction maps in the context illustrated by FIGS. 11A-11C.

### DETAILED DESCRIPTION

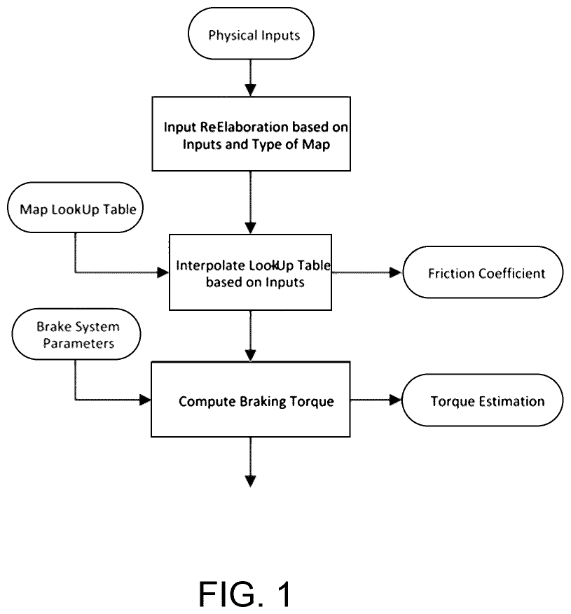

With reference to FIGS. 1-12, a method for estimating a braking torque of a braking system for vehicles under operating conditions is described.

This method comprises a step a) of detecting or calculating a first input quantity and a second input quantity which are representative of operating conditions of the braking system.

The first detected or calculated input quantity comprises a temperature T of a brake disc of the braking system.

The second detected or calculated input quantity comprises a quantity depending on a pressure P of the braking system or on a contact pressure PC between friction surfaces of the braking system.

The method then includes a step b) of determining, based on said detected or calculated first input quantity and second input quantity, a braking friction coefficient μ representative of the braking friction or efficiency expected under the conditions defined by the detected or calculated values of said first input quantity and second input quantity.

Such a determining step b) is carried out by consulting, by means of electronic processing, a predefined friction map, or a corresponding predefined friction map table, which are digitally stored.

The method finally comprises a step c) of estimating the braking torque C based on the aforesaid determined braking friction coefficient μ and on geometric and/or structural and/or operating parameters of the braking system.

In accordance with different possible embodiments of the method, the aforesaid second input quantity is any one of the following quantities:
pressure P of the braking system, or
contact pressure PC between friction surfaces of the braking system, or
product of the pressure P of the braking system multiplied by the rotation speed vr of a wheel on which the braking system acts, or
product of the contact pressure PC between friction surfaces of the braking system multiplied by the rotation speed vr of a wheel on which the braking system acts.

According to an implementation option, the method is performed with reference to a braking system comprising at least one brake caliper and at least one brake disc, and where the aforesaid friction surfaces of the braking system are the surfaces of the braking system disc and the surfaces of the brake caliper pads, that are configured to come into mutual contact during a braking event.

In that case, the aforesaid rotation speed vr is the rotation speed of the wheel on which the brake disc and the brake caliper of the braking system act.

In accordance with an embodiment of the method, the aforesaid detecting or calculating step a) comprises detecting the first input quantity and the second input quantity based on a real-time acquisition of said quantities during the operating conditions of the braking system.

According to another embodiment, the aforesaid detecting or calculating step a) comprises calculating the first input quantity and the second input quantity off-line based on telemetrically acquired data related to the operating conditions of the braking system.

In accordance with an embodiment of the method, the aforesaid friction map table comprises a predefined lookup-type table indicating the braking friction coefficient μ as a function of the aforesaid first and second input quantities.

In that case, the determining step b) comprises determining the braking friction coefficient μ based on a reading and/or interpolation carried out on the aforesaid lookup table by means of electronic processing.

According to an implementation option, the aforesaid friction map comprises a predefined color friction map, showing, by means of color graphics, the braking friction coefficient μ as a function of the first and second input quantities.

In that case, the determining step b) comprises determining the braking friction coefficient μ based on a reading of such a color map.

According to an embodiment, the aforesaid geometric and/or structural and/or operating parameters of the braking system used in the method in the estimating step c) comprise geometric parameters related to pistons of the brake caliper and operating parameters of the brake caliper.

According to an implementation option, the braking torque C is calculated as the product of the friction coefficient μ multiplied by the sum of the area Aₚᵢₛₜ of the pistons of the brake caliper (both sides) multiplied by the effective radius R_{eff} of the brake caliper multiplied by the system pressure Pᵢₘₚ of the brake caliper:

$$C = u \cdot {A}_{p i s t} \cdot {R}_{eff} \cdot {P}_{imp}$$

According to an embodiment of the method, one or more friction maps, or one or more corresponding friction map tables, constructed based on experimental assessments, are stored in a control unit of the vehicle or of the vehicle braking system.

Each of such one or more friction maps, or one or more corresponding friction map tables, is characterized by respective specific first and second input quantity, each expressed in a respective unit of measurement.

In accordance with an implementation option, the method comprises the further step of preparing the first input quantity and the second input quantity based on detected and/or measured quantities provided to the control unit as a function of the specific first and second input quantities, and respective measurement units, provided by the specific friction map or corresponding friction map table, among those stored, which is used in the determining step b).

According to an implementation option, the aforesaid step of preparing input quantities comprises adapting the units of measurement of the detected quantities to the units of measurement provided in the friction map, or corresponding friction map table, that is used.

In accordance with a particular implementation option, the step of preparing input quantities further comprises calculating the first and/or second input quantity based on the acquired quantities so as to make them consistent with the provision of the friction map, or corresponding friction map table, that is used.

In other words, if there is no immediate consistency between the quantities acquired and the quantities provided for a particular friction map to be used, or there is no immediate consistency between the units of measurement of the quantities acquired and the units of measurement with which the map was constructed, the method comprises a step of pre-processing the input quantities such as to determine such a consistency.

Those skilled in the art easily understand that such a step can be applied in many different examples:
for example, if the speed is acquired in Km/h whereas the map has been constructed based on the rotation speed or number of wheel revolutions, the method includes a step of preparing the input quantity to be used to consult the map comprising a conversion in which the linear speed in Km/h is converted into the rotation speed considering the rolling radius;
or, again by way of example, if a quantity acquired is the braking pressure of the braking system, and the friction map has been constructed based on the pressure on the brake pad, the method includes a step of preparing the input quantity to be used for consulting the map comprising a conversion in which the system pressure is multiplied by the area of the pistons of the brake caliper insisting on the brake pad and divided by the area of the aforesaid pad for obtaining the related contact pressure.

According to another embodiment, still in order to guarantee, but in a different way, the consistency between the quantities acquired and the quantities used for consulting a friction map, the method comprises providing, by the control unit, a friction map or corresponding modified friction map table, based on of the quantities that are actually acquired and the respective units of measurement.

For example, according to a possible implementation example, if different units of measurement are used, various friction maps are constructed by changing unit of measurement (e.g. both on the x-axis and the y-axis).

According to an embodiment, the method is performed on a braking system comprising a plurality of brake calipers and respective brake discs, and where said steps a), b), c) of the method are carried out for each of the plurality of brake calipers and respective brake discs.

According to an implementation option, the braking friction coefficient μ is determined for each axle of the braking system, i.e., a single braking friction coefficient value μ is determined for both brake calipers and respective brake discs of an axle.

According to an implementation option, the braking friction coefficient μ is determined for each brake caliper and respective brake disc of an axle.

In other words, in different possible implementation options, the friction coefficient can be calculated, based on the available inputs, both at axle level (a single value for both front or rear brakes) and at corner level (thus the value of the friction coefficient on the right brake can be different from the value of the friction coefficient on the left brake, also on the same axle).

According to an implementation option, all the steps of the aforesaid embodiments of the method for estimating a braking torque are performed by electronic processing means.

A method is described below for estimating quantities related to the operation of a braking system for vehicles.

Such a method includes carrying out a method for estimating a braking torque of a braking system according to any one of the embodiments previously illustrated, and then estimating at least one further quantity related to the operation of the braking system, based on the estimated braking torque and further detected or measured operating parameters.

According to different embodiments of such a method, the aforesaid at least one further quantity related to the operation of the braking system comprises:
power or energy dissipated during the braking action, and/or
aerodynamic resistance or other parameter associated with the vehicle dynamics; and/or
brake temperature; and/or
adjustment parameters in a braking system of the brake-by-wire type, BBW.

According to an embodiment, a power dissipated during the braking action is estimated by multiplying the estimated braking torque by a speed of the wheel.

According to an implementation option, the aforesaid estimated power dissipated during the braking action is used in association with a thermal model for estimating the temperature of the brake or other components of the braking system of a wheel.

According to another embodiment, an aerodynamic resistance or other parameter associated with the vehicle dynamics is estimated based on the estimated braking torque and a detected or calculated traction torque of the vehicle.

According to another embodiment, based on of the estimated braking torque on an axle directly controlled by the driver in a brake-by-wire, BBW, actuation system, at least one braking torque target is estimated for at least one respective other axle of the brake-by-wire actuation system.

According to an implementation option, all the steps of the aforesaid embodiments of the method for estimating quantities related to the operation of a braking system are performed by electronic processing means.

A method, also encompassed by the present invention, for estimating an actuation pressure P to be applied to a braking system of a vehicle to obtain a target braking torque value Ct is described below.

Such a method comprises the steps i) of detecting or calculating a temperature T of a disc brake of the braking system and ii) determining, based on the aforesaid temperature T of the brake disc and the aforesaid target braking torque value Ct, the pressure P to be applied to the braking system.

The determining step ii) is carried out by consulting, by means of electronic processing, a predefined inverse friction map, or a corresponding predefined inverse friction map table, that are digitally stored.

According to an implementation option, the aforesaid inverse friction map or corresponding inverse friction map table is calculated from a friction map or corresponding friction map table, and stored before carrying out the steps of the method.

According to an embodiment of this method, the aforesaid inverse friction map table comprises a predefined lookup inverse table which indicates the pressure P to be applied to the braking system as a function of the temperature T of brake disc and the braking torque C.

In that case, the determining step ii) comprises determining the pressure P to be applied to the braking system based on a reading and/or interpolation carried out on said lookup inverse table by means of electronic processing.

According to an implementation option, the aforesaid inverse friction map table comprises a predefined lookup inverse table which provides, as a function of the temperature T of brake disc and the braking torque C, an output value PV equal to the product of the pressure P to be applied to the braking system multiplied by a speed of the wheel on which the braking system acts.

In that case, the determining step ii) comprises:
obtaining, by reading and/or interpolating said lookup inverse table by means of electronic processing, the aforesaid output value equal to the product of the pressure P to be applied to the braking system by a speed of the wheel;
detecting or calculating the speed of the wheel under the current operating conditions;
calculating the pressure P to be applied to the braking system based on said output value PV obtained from the inverse table and said detected or calculated speed of the wheel.

In accordance with an implementation option, the detected or calculated speed of the wheel is the angular speed ωr of the wheel.

In that case, the step of calculating the pressure P to be applied to the braking system comprises dividing the output value PV by the angular speed ωr of the wheel, according to the formula:

$$P = PV / ω r$$

According to an implementation option, the aforesaid steps of detecting or calculating the temperature T of a brake disc of the braking system and the speed of the wheel comprise detecting or calculating such quantities based on a real time acquisition of such quantities, during the operating conditions of the braking system.

According to another implementation option, the aforesaid steps of detecting or calculating the temperature T of a brake disc of the braking system and the speed of the wheel comprise detecting or calculating such quantities based on off-line calculations based on telemetrically acquired data related to the operating conditions of the braking system.

In accordance with an embodiment of this method, one or more inverse friction maps, or one or more corresponding inverse friction map tables, are constructed based on experimental assessments or based on a re-elaboration of direct friction maps, and are stored in a control unit of the vehicle or the braking system of the vehicle.

Each of such one or more inverse friction maps, or one or more corresponding inverse friction map tables, is associated with specific measurement units of the temperature T of brake disc and of the target braking torque Ct.

According to an embodiment, the method comprises the further step of preparing the quantities for consulting the inverse friction map, or corresponding inverse friction map table, by adapting the units of measurement of the detected quantities to the units of measurement provided by the inverse friction map, or corresponding inverse friction map table.

A further method, also encompassed by the invention, for estimating an actuation pressure P to be applied to a braking system of a vehicle to obtain a target braking torque value Ct is described below.

Such a method comprises the following steps:
A) detecting or calculating a first input quantity and a second input quantity, wherein the first detected or calculated input quantity comprises a temperature T of a brake disc of the braking system, and the second detected or calculated input quantity comprises a quantity depending on the desired target braking torque Ct;
B) calculating, based on the first input quantity and second input quantity, based on a first braking friction coefficient test value μ1, and based on geometric and/or structural and/or operating parameters of the braking system, an estimated actuation pressure value Ps;
C) determining, based on the aforesaid temperature T of a brake disc of the braking system and the aforesaid estimated actuation pressure value Ps, a second braking friction coefficient value μ2; this step is carried out consulting, by means of electronic processing, a predefined friction map or a corresponding predefined friction map table, digitally stored;
D) calculating the estimated braking torque value C based on said second braking friction coefficient value μ2 and on geometric and/or structural and/or operating parameters of the braking system;
E) comparing the estimated braking torque value Cs with the target braking torque value Ct;
F) if the difference between the estimated braking torque value Cs and the target braking torque value Ct is less than a predetermined threshold, said estimated actuation pressure value Ps calculated in step B) is considered as the actuation pressure P to be applied to the braking system of a vehicle;
   if instead the difference between the estimated braking torque value Cs and the target braking torque value Ct is greater than said predetermined threshold, the aforesaid steps B), C), D) are iterated until the difference between the estimated braking torque value Cs and the target braking torque value Ct becomes less than said predetermined threshold, and the estimated actuation pressure value Ps, calculated in step B) of the iteration, is considered as the actuation pressure P to be applied to the braking system of a vehicle.

According to an implementation option, the aforesaid second detected or calculated input quantity comprises the desired target braking torque Ct, or the product of the target braking torque Ct multiplied by the speed of the wheel on which the braking system acts.

According to an implementation option, all the steps of the aforesaid embodiments of the method for estimating a pressure to be applied to a braking system of a vehicle are performed by electronic processing means.

There is described below a method for actuating a brake-by-wire (BBW) braking system for a vehicle mounted on a vehicle, comprising a first braking axle directly controlled by the driver by applying a first axle actuation pressure Pa1, and a second axle controlled by a brake-by-wire control system configured to apply a second axle controlled pressure Pa2 to the second axle.

Such a method comprises the following steps:
carrying out a method for estimating a braking torque (according to any one of the embodiments of such a method previously described), to obtain an estimated braking torque value C1, wherein the aforesaid second input quantity is the first axle actuation pressure Pa1 controlled by the driver;
carrying out a method for estimating a pressure P to be applied to a braking system of a vehicle (according to any one of the embodiments of such a method previously described), where the target braking torque value Ct2 is associated with a predefined known relationship with said estimated braking torque value (C1) and/or is calculated from said estimated braking torque value C1;
finally, applying, to the second axle, by the brake-by-wire control system, as second axle controlled pressure Pa2, a pressure equal to said pressure P, obtained from the method for estimating a braking pressure.

According to an implementation option, all the steps of the aforesaid method for actuating a brake-by-wire type braking system are performed by electronic processing means.

It should be noted that, in possible implementation options of the methods illustrated above, all the calculations can be performed both in real time and off-line a posteriori.

Further details of the method will be given below, again referring to FIGS. 1-12, for illustrative and non-limiting purposes only, according to particular embodiments of the invention.

FIG. 1 is a simplified flow diagram of the steps included in an embodiment of the method for estimating a braking torque of a braking system. Such a processing flow includes the following steps.
1. Detecting or calculating two input quantities, a first quantity and a second quantity, where the first quantity comprises a temperature of the disc brake (detected or calculated, representative of current conditions) and the second quantity comprises a quantity dependent on a pressure (detected or calculated, representative of current conditions); and the second quantity can be one of the following:
   i. Pressure of the braking system.
   ii. Contact pressure between the braking surfaces (disc and pad).
   iii. Product of the pressure of the system by the wheel speed.
   iv. Product of the contact pressure by the wheel speed.

Should the quantities originally detected not be consistent with the subsequent steps, a calculation or a conversion must be included so as to make them consistent with the friction map to be used in the next point 2.

The magnitudes can be acquired and used in real-time or off-line a posteriori.
2. From such input quantities, the method provides determining the friction coefficient (or efficiency) of the brake by interpolation of the lookup table known as the “Direct Friction Map”. This value represents the best estimate of the friction coefficient under the “current” conditions as measured at point 1 above.

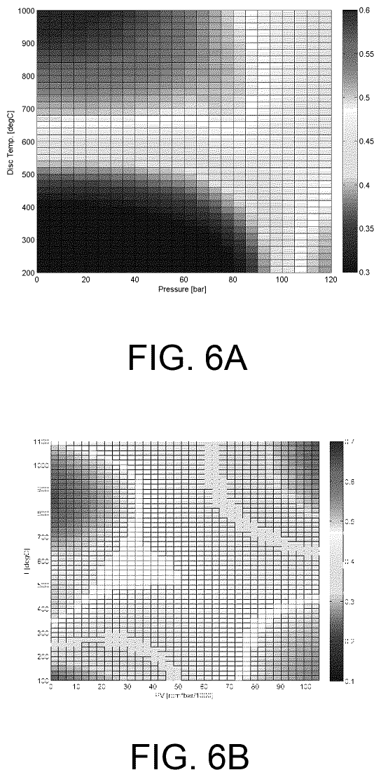

Examples of direct friction maps are illustrated in FIGS. 6A (having as the second input quantity the aforesaid quantities i. or ii.) and 6B (having as the second input quantity the aforesaid quantities iii. or iv.).

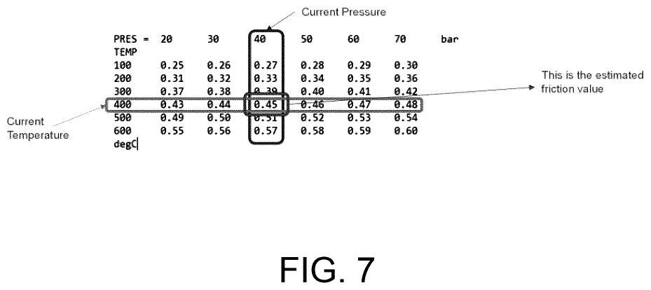

An example of a look-up table corresponding to a direct friction map is illustrated in FIG. 7.

The friction coefficient can be calculated, based on the available inputs, both at axle level (a single value for both the front or rear brakes) and at corner level (right brake different from the left brake also on the same axle).
3. Once the friction coefficient has been estimated, it is possible to use this value together with the system data (fixed values related to the geometries of the braking system) for calculating the braking torque at the wheel. The braking torque can be estimated in real-time or with an off-line routine a posteriori.

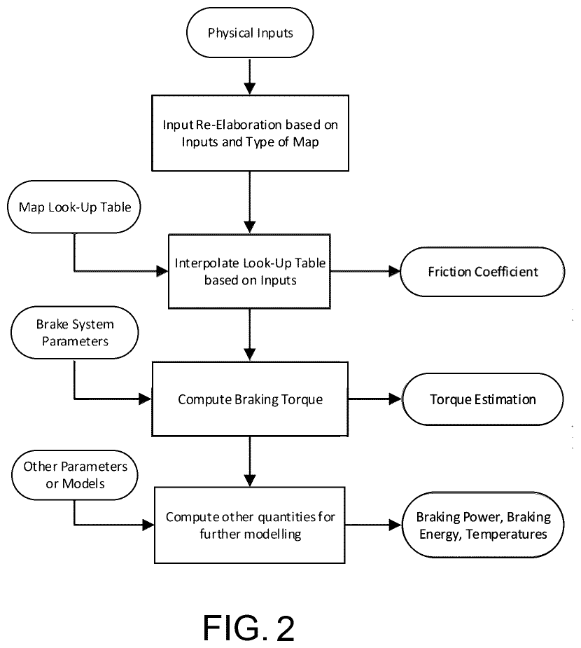

FIG. 2 is a simplified flow diagram of the steps included in an embodiment of a method for estimating quantities related to the operation of a braking system for vehicles.

With respect to FIG. 1, such a figure illustrates the following further step:
4. the braking torque, estimated with the method illustrated in FIG. 1, can be used for further calculations or for estimating secondary quantities from the original estimate combined with other parameters or models.

In different implementation options, this includes:
multiplying the torque by the wheel speed for estimating the dissipated power during the braking action;
combining different torques (including the braking torque and for example the traction torques) for estimating aerodynamic resistance or other quantities connected with the dynamics of the vehicle;
using the power dissipated by the brake in a thermal model for estimating the temperature of the brake or other components of the wheel corner;
using the braking torque generated on an axle directly controlled by the driver as a target for other brake-by-wire actuation systems on other axles.

All of the aforesaid calculations can be performed both in real-time and off-line a posteriori.

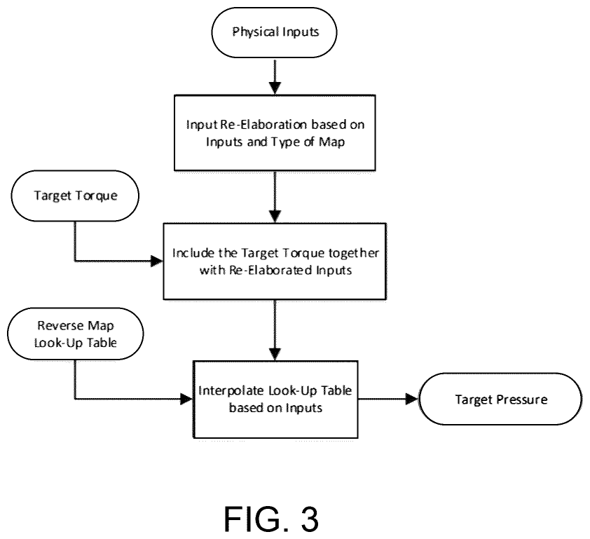

FIG. 3 is a simplified flow diagram of the steps included in an embodiment of a method for estimating a pressure to be applied to a braking system of a vehicle, for obtaining a target braking torque value Ct. Such a processing flow includes the following steps.
1. Detecting or calculating two input quantities, a first quantity and a second quantity, where the first quantity comprises a temperature of the disc brake (detected or calculated, representative of current conditions) and the second quantity comprises a quantity dependent on a target torque (i.e. the braking torque to be applied by the brake).

The second quantity can be one of the following:
i. Target braking torque
ii. Product of target torque multiplied by current wheel speed

Should the quantities originally detected not be consistent with the subsequent steps, a calculation or a conversion must be included so as to make them consistent with the friction map to be used at point 2 below.

The aforesaid quantities can be acquired and used in real-time or off-line a posteriori.
2. From such input quantities, the method provides determining the target pressure by interpolation of a look-up table known as the “inverse friction map”. This value represents the best estimate of the pressure to be applied under “current” conditions as measured at point 1 above, in order to ensure the target torque at the wheel.

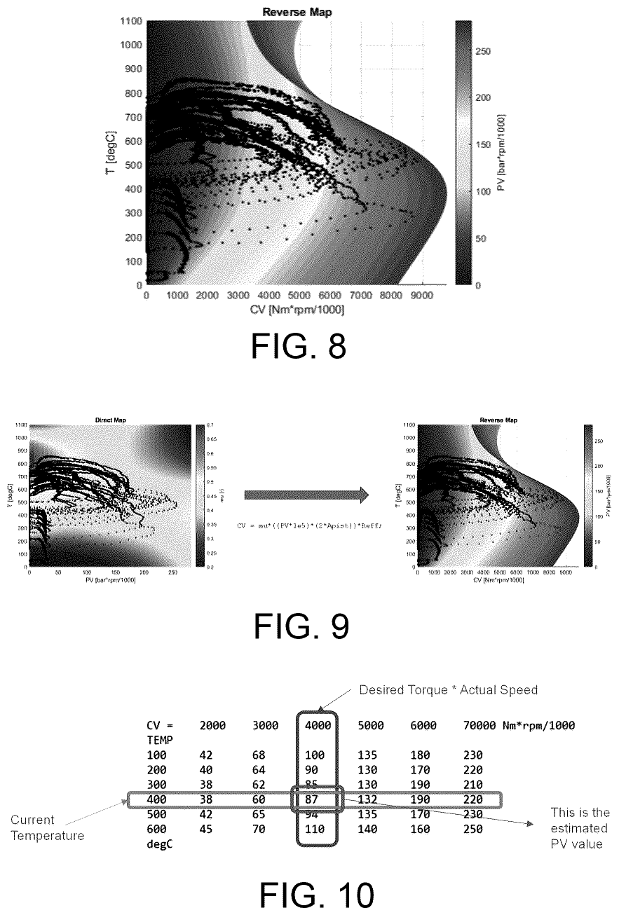

An example of an inverse friction map is illustrated in FIG. 8.

A calculation example of an inverse friction map from a direct friction map is illustrated in FIG. 9.

An example of a look-up table corresponding to an inverse friction map is illustrated in FIG. 10.

The aforesaid target pressure can be calculated, based on the available inputs, both at axle level (a single value for both the front or rear brakes) and at corner level (right brake different from the left brake also on the same axle).

The output of the inverse friction map can directly be the target pressure or the product of the target pressure multiplied by the current wheel speed. In the latter case a further calculation step is necessary in order to extrapolate the target pressure only.

All of the calculations can be carried out both in real-time and off-line a posteriori.

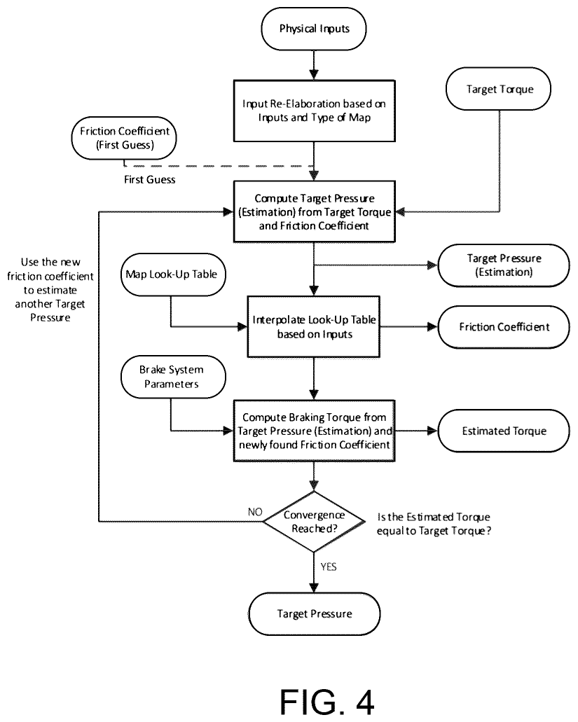

FIG. 4 is a simplified flow diagram of the steps included in another embodiment of a method for estimating a pressure to be applied to a braking system of a vehicle, for obtaining a target braking torque value Ct.

In that case, the actuation pressure is estimated starting not from an inverse friction map, but through the following processing flow with iteration, from a direct friction map.
1. Detecting or calculating two input quantities, a first quantity and a second quantity, where the first quantity comprises a temperature of the disc brake (detected or calculated, representative of current conditions) and the second quantity comprises a quantity dependent on a target torque (i.e. the braking torque to be applied by the brake). The second quantity can be one of the following:
i. Target braking torque.
ii. Product of target torque by current wheel speed.

Should the quantities originally detected not be consistent with the subsequent steps, a calculation or a conversion must be included so as to make them consistent with the friction map to be used in point 3 below.

The quantities can be acquired and used in real-time or off-line a posteriori.
2. Starting from such input quantities and a first (braking) friction coefficient value, the method provides determining a first target pressure estimate by direct calculation (dividing the target torque by the friction value and by other geometric parameters of the braking system).
3. Using the target pressure estimate to calculate a new “current” friction coefficient by interpolation of the look-up table corresponding to the “direct friction map”.
4. Calculating the estimated torque from the target pressure estimate, the new friction coefficient and the geometric parameters of the braking system. If such an estimated torque is sufficiently close to the target torque (entered at point 1 above), the estimate can be considered correct and thus the target pressure can be used as an output. Otherwise it is necessary to return to point 2 and calculate a new target pressure estimate, this time using the friction coefficient calculated at point 3 instead of the initially hypothesized value.

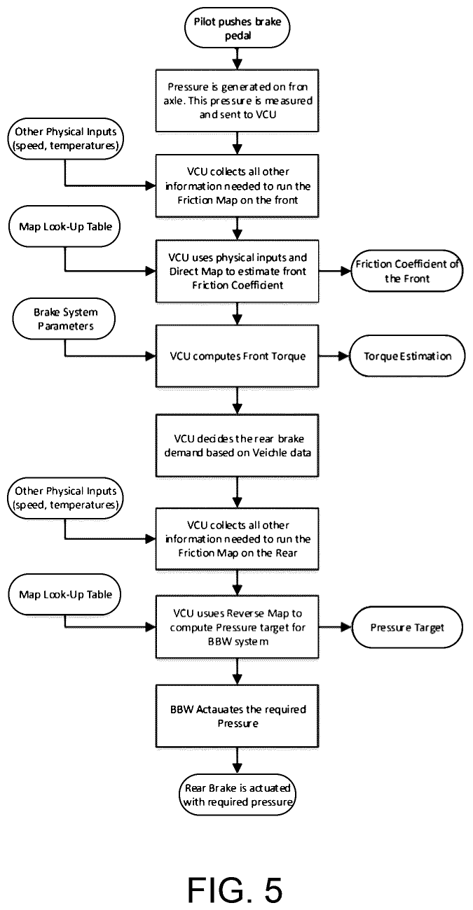

FIG. 5 is a simplified flow diagram of the steps included in another embodiment of a method for actuating a brake-by-wire braking system for vehicles, using the methods mentioned above. In this embodiment, a combined use of the direct and inverse friction maps on a vehicle with a brake-by-wire braking system is used.

In particular, it is possible to use the braking torque estimate by (direct) friction map and the calculation of the target pressure in a combined manner on a vehicle provided with two braking axles, the first under the driver's direct control (who thus acts by means of braking pressure directly on the brake), the second under the control of a BBW system and which must thus apply a braking pressure based on the driver's action on the first axle and other logics inside a vehicle control unit (VCU).

FIG. 5 shows by way of example the processing flow when the actuated axle is the front one and that under BBW is the rear one, but those skilled in the art can easily understand the teaching provided by also applying it to the opposite case.

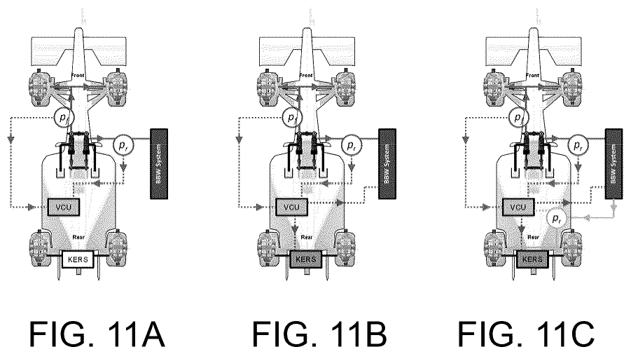

The braking system to which reference is made is that illustrated in FIGS. 11A-11C:
FIG. 11A: the driver performs a braking action on the master cylinders of the brake, but only the pressure on the front axle is applied to the brake calipers;
FIG. 11B: the vehicle control unit (VCU) processes the requests on the front and rear axles and processes targets for the KERS and BBW actuators;
FIG. 11C: the BBW actuator sets the pressure on the brake calipers of the rear axle.

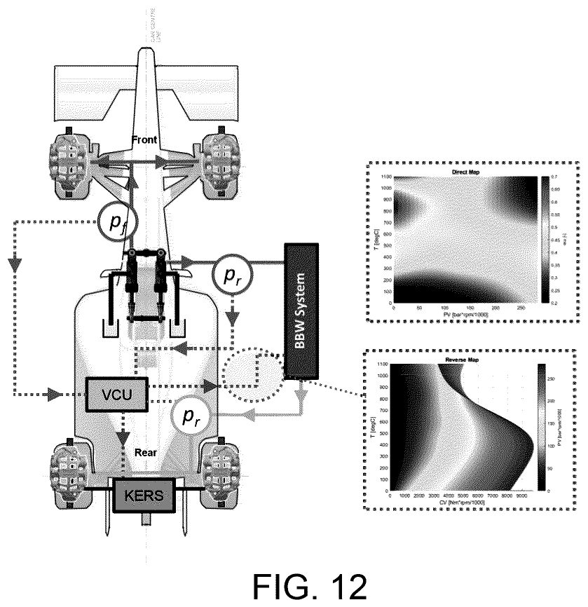

The use of the friction maps in this context is illustrated in FIG. 12:
the direct friction map converts the front actuation pressure into an estimated braking torque; this is useful for estimating the actual braking action on the front axle, and not only the related command action;
the inverse friction map converts the rear torque request (calculated from the estimated front torque) into an equivalent braking pressure to be applied to the BBW axle; this is useful for avoiding biases when performing the braking action.

As can be seen, the objects of the present invention, as previously indicated, are fully achieved by the methods described above by virtue of the features disclosed above in detail. The advantages and technical problems solved by the method according to the invention have already been mentioned above, with reference to the various features and aspects of the method.

In particular, the methods disclosed above allow estimating important operating quantities of the braking system, such as for example a braking torque or a pressure to be applied to the brake disc for obtaining a certain braking torque, automatically and reliably, also usable in real time, applicable to each operating condition of the braking system associable with a braking event.

In order to meet contingent needs, those skilled in the art may make changes and adaptations to the embodiments of the methods described above or can replace elements with others which are functionally equivalent, without departing from the scope of the following claims. Each of the features described above as belonging to a possible embodiment can be implemented irrespective of the other embodiments described.

1-20. (canceled)

21. A method for estimating a braking torque of a braking system for vehicles under operating conditions, comprising:
a) detecting or calculating a first input quantity and a second input quantity which are representative of operating conditions of the braking system, wherein the first detected or calculated input quantity comprises a temperature of a brake disc of the braking system, and the second detected or calculated input quantity comprises a quantity depending on a pressure of the braking system or on a contact pressure between friction surfaces of the braking system;
b) determining, based on said detected or calculated first input quantity and second input quantity, a braking friction coefficient representative of the braking friction or efficiency expected under the conditions defined by the detected or calculated values of said first input quantity and second input quantity,
wherein said determining step b) is carried out by consulting, by means of electronic processing, a predefined friction map, or a corresponding predefined friction map table, which are digitally stored;
c) estimating the braking torque based on said determined braking friction coefficient and on geometric and/or structural and/or operating parameters of the braking system.

22. A method according to claim 21, wherein said second input quantity is any one of the following quantities:
pressure of the braking system, or
contact pressure between friction surfaces of the braking system, or
product of the pressure of the braking system multiplied by the rotation speed of a wheel on which the braking system acts, or
product of the contact pressure between friction surfaces of the braking system multiplied by the rotation speed of a wheel on which the braking system acts.

23. A method according to claim 22, wherein the braking system comprises at least one brake caliper and one brake disc, and wherein said friction surfaces of the braking system are the surfaces of the braking system disc and the surfaces of the brake caliper pads, which are configured to come into mutual contact during a braking event,
and wherein said rotation speed is the rotation speed of the wheel on which said brake disc and brake caliper of the braking system act.

24. A method according to claim 21, wherein said detecting or calculating step a) comprises detecting said first input quantity and second input quantity based on a real-time acquisition of said quantities during the operating conditions of the braking system,
or wherein said detecting or calculating step a) comprises calculating said first input quantity and second input quantity off-line based on telemetrically acquired data related to the operating conditions of the braking system,
or wherein said friction map table comprises a predefined lookup table providing the braking friction coefficient as a function of said first and second input quantities, and wherein the determining step b) comprises determining the braking friction coefficient based on a reading and/or interpolation carried out on said lookup table by means of electronic processing.

25. A method according to claim 23, wherein said geometric and/or structural and/or operating parameters of the braking system used in the estimating step c) comprise geometric parameters related to pistons of the brake caliper and operating parameters of the brake caliper.

26. A method according to claim 25, wherein the braking torque is calculated as the product of the friction coefficient multiplied by the sum of the area of the pistons of the brake caliper, multiplied by the brake caliper effective radius multiplied by the system pressure of the brake caliper.

27. A method according to claim 21, wherein one or more friction maps, or one or more corresponding friction map tables, constructed on the basis of experimental assessments, are stored in a control unit of the vehicle or of the vehicle braking system,
wherein each of said one or more friction maps, or each of said one or more corresponding friction map tables, is characterized by respective specific first and second input quantities, each expressed in a respective unit of measurement,
wherein the method comprises the further step of preparing the first input quantity and the second input quantity based on detected and/or measured quantities provided to said control unit according to the specific first and second input quantities, and respective units of measurement, provided by the specific friction map or corresponding friction map table, among those stored, which is used in the determining step b).

28. A method according to claim 27, wherein said step of preparing input quantities comprises adapting the units of measurement of the detected quantities to the units of measurement provided in the friction map or corresponding friction map table that is used,
and/or wherein the step of preparing input quantities further comprises calculating the first and/or second input quantity based on the acquired quantities so as to make them consistent with the provisions of the friction map or corresponding friction map table that is used,
and/or wherein the method further comprises the step of preparing, by the control unit, a modified friction map, or corresponding modified friction map table, based on the quantities actually acquired and of the respective measurement units.

29. A method according to claim 21, wherein the braking system comprises a plurality of brake calipers and respective brake discs, and wherein said steps a), b) and c) of the method are carried out for each of the plurality of brake calipers and respective brake discs,
wherein the braking friction coefficient is determined for each axle of the braking system, i.e., a single braking friction coefficient value is determined for both brake calipers and respective brake discs of an axle,
or wherein the braking friction coefficient is determined for each brake caliper and respective brake disc of an axle.

30. A method for estimating quantities related to the operation of a braking system for vehicles, comprising
carrying out a method for estimating a braking torque of a braking system according to claim 21;
estimating at least one further quantity related to the operation of the braking system based on the estimated braking torque and further detected or measured operating parameters,
wherein said at least one further quantity related to the operation of the braking system comprises:
power or energy dissipated during the braking action, and/or
aerodynamic resistance or other parameter associated with the vehicle dynamics; and/or
brake temperature; and/or
adjustment parameters in a braking system of the brake-by-wire type, BBW.

31. A method according to claim 30, wherein:
a power dissipated during the braking action is estimated by multiplying the estimated braking torque by a speed of the wheel; and/or
an aerodynamic resistance or other parameter associated with the vehicle dynamics is estimated based on the estimated braking torque and a detected or calculated traction torque of the vehicle; and/or
based on the estimated braking torque on an axle directly controlled by the driver in a brake-by-wire, BBW, actuation system, at least one braking torque target is estimated for at least one respective other axle of the brake-by-wire actuation system.

32. A method according to claim 31, wherein said estimated power dissipated during the braking action is used in association with a thermal model for estimating the temperature of the brake or other components of the braking system of a wheel.

33. A method for estimating a pressure to be applied to a braking system of a vehicle to obtain a target braking torque value, wherein the method comprises:
i) detecting or calculating a temperature of a brake disc of the braking system;
ii) determining, based on said temperature of a brake disc of the braking system and said target braking torque value, the pressure to be applied to the braking system,
wherein said determining step ii) is carried out by consulting, by means of electronic processing, a predefined inverse friction map or a corresponding predefined inverse friction map table, digitally stored.

34. A method according to claim 33, wherein said inverse friction map table comprises a predefined lookup inverse table which indicates the pressure to be applied to the braking system as a function of the temperature of brake disc and the braking torque,
and wherein the determining step ii) comprises determining the pressure to be applied to the braking system based on a reading and/or interpolation carried out on said lookup inverse table by means of electronic processing.

35. A method according to claim 33, wherein said inverse friction map table comprises a predefined lookup inverse table which provides, as a function of the temperature of brake disc and the braking torque, an output value equal to the product of the pressure to be applied to the braking system multiplied by a speed of the wheel on which the braking system acts,
and wherein the determining step ii) comprises:
obtaining, by reading and/or interpolating said lookup inverse table by means of electronic processing, said output value equal to the product of the pressure to be applied to the braking system multiplied by a speed of the wheel;
detecting or calculating said speed of the wheel under the current operating conditions;
calculating the pressure to be applied to the braking system based on said output value obtained from the inverse table and said detected or calculated speed of the wheel.

36. A method according to claim 35, wherein the detected or calculated speed of the wheel is the angular speed of the wheel, and wherein said step of calculating the pressure to be applied to the braking system comprises dividing the output value by the angular speed of the wheel according to the formula:
$$P = PV / ω r$$

37. A method according to claim 33, wherein said steps of detecting or calculating the temperature of a brake disc of the braking system and the speed of the wheel comprise detecting or calculating said quantities on the basis of a real-time acquisition of said quantities during the operating conditions of the braking system, or on the basis of off-line calculations based on data acquired by telemetry related to the operating conditions of the braking system,
and/or wherein one or more inverse friction maps, or one or more corresponding inverse friction map tables, are constructed based on experimental assessments or based on a re-processing of direct friction maps, and are stored in a control unit of the vehicle or of the vehicle braking system,
wherein each of said one or more inverse friction maps, or one or more corresponding inverse friction map tables, is associated with specific measurement units of brake disc temperature and target braking torque,
wherein the method comprises the further step of preparing the quantities for consulting the inverse friction map, or corresponding inverse friction map table, by adapting the measurement units of the detected quantities to the measurement units provided by the inverse friction map, or corresponding inverse friction map table.

38. A method for estimating an actuation pressure to be applied to a braking system of a vehicle to obtain a target braking torque value, wherein the method comprises:
A) detecting or calculating a first input quantity and a second input quantity, wherein the first detected or calculated input quantity comprises a temperature of a brake disc of the braking system, and the second detected or calculated input quantity comprises a quantity depending on the desired target braking torque;
B) calculating, based on said first input quantity and second input quantity, based on a first braking friction coefficient test value, and based on geometric and/or structural and/or operating parameters of the braking system, an estimated actuation pressure value;
C) determining, based on said temperature of a brake disc of the braking system and said estimated actuation pressure value, a second braking friction coefficient value, wherein said determining step is carried out consulting, by means of electronic processing, a predefined friction map or a corresponding predefined friction map table, digitally stored;
D) calculating the estimated braking torque value based on said second braking friction coefficient value and on geometric and/or structural and/or operating parameters of the braking system;
E) comparing the estimated braking torque value with the target braking torque value;
F) if the difference between the estimated braking torque value and the target braking torque value is less than a predetermined threshold, said estimated actuation pressure value calculated in step B) is considered as the actuation pressure to be applied to the braking system of a vehicle;
if the difference between the estimated braking torque value and the target braking torque value is greater than said predetermined threshold, said steps B), C), D) are iterated until the difference between the estimated braking torque value and the target braking torque value becomes less than said predetermined threshold, and the estimated actuation pressure value, calculated in step B) of the last iteration, is considered as the actuation pressure to be applied to the braking system of a vehicle.

39. A method according to claim 38, wherein said second detected or calculated input quantity comprises the desired target braking torque, or the product of the target braking torque multiplied by the speed of the wheel on which the braking system acts.

40. A method for actuating a brake-by-wire, BBW, braking system for a vehicle, comprising a first braking axle directly controlled by the driver by applying a first axle actuation pressure, and a second axle controlled by a brake-by-wire control system configured to apply a second-axle controlled pressure to the second axle, wherein the method comprises:
carrying out a method for estimating a braking torque, to obtain an estimated braking torque value, wherein said second input quantity is the first axle actuation pressure controlled by the driver;
carrying out a method for estimating a pressure to be applied to a braking system of a vehicle according to claim 33, to obtain a pressure to be applied to the braking system, wherein the target braking torque value is associated with a predefined known relationship with said estimated braking torque value and/or is calculated from said estimated braking torque value;
applying to the second axle, by the brake-by-wire control system, as the second-axle controlled pressure, a pressure equal to said pressure, obtained by the method for estimating a braking pressure.
